(19) United States
(12) Patent Application Publication
(10) Pub. No.: US 2021/0092136 A1
(43) Pub. Date: Mar. 25, 2021

(54) Protecting Against Remote Desktop Protocol Intrusions

(71) Applicant: PC Matic Inc, Sioux City, IA (US)

(72) Inventors: Robert J. Woodworth, Charleston, SC (US); Robert J. Cheng, Myrtle Beach, SC (US)

(21) Appl. No.: 16/924,861

(22) Filed: Jul. 9, 2020

Related U.S. Application Data
(60) Provisional application No. 62/904,694, filed on Sep. 24, 2019.

(51) Int. Cl. H04L 29/06; H04L 29/08

(52) U.S. Cl. CPC H04L 63/1416; H04L 67/08; H04L 63/0876; H04L 63/126

(57) ABSTRACT

A system for protecting against remote access protocol intrusions includes an intrusion detection module that monitors the remote desktop protocol of a target computer, looking for connections (or attempted connections) from a connecting device (e.g. a remote computer). Upon detecting the connection (or attempted connection), the intrusion detection module determines if the connecting device is authorized to make a remote desktop protocol connection to the target computer using, in some embodiments, white lists and/or black lists. In some embodiments, the intrusion detection module communicates with a verification program the must be run on the connecting device and tries to receive a packet containing an identification of the connecting device. If the packet is not received or the connecting device is not authorized, the intrusion detection module disconnects the connection from the connecting device.

### CROSS-REFERENCE TO RELATED APPLICATION

This application claims the benefit of U.S. provisional application No. 62/904,694 filed on Sep. 24, 2019, the disclosure of which is incorporated by reference.

### FIELD

This invention relates to the field of computer intrusions and more particularly to a system for protecting from intrusions that utilize the remote desktop protocol.

### BACKGROUND

Many computer operating systems provide a protocol for remotely controlling operation of the computer. Although other names for such protocol are possible, one such name is “remote desktop protocol,” or RDP. For the remainder of this document, the term “remote desktop protocol” is used to describe such protocols.

Remote desktop protocols are very useful for many situations. Consider a server on which a technician needs to change a simple parameter in the registry. The technician is always able to travel to the location of that server and make those changes by logging in at the console of that server, but the time and effort of the travel increases the cost of maintaining that server. Many servers are maintained by information technologists that are remote from the servers, especially in small businesses. Updating, troubleshooting, and backing up of such servers becomes cost prohibitive when travel is required for the technician to be at the premise of the servers.

Further, many companies use remote desktop protocol during troubleshooting of various problems on home computers or work computers. When a user calls a trouble hotline, often the technician at the hotline will use remote desktop protocol to gain access to the user's computer, rather than trying to instruct the user as to what they need to do and having the user describe the resulting display. All of the above are legitimate uses for remote desktop protocol.

For security, the remote desktop protocols often require that the remote computer present proper login credentials before allowing entry into the controlled computer, though in some systems, security issues allow remote access without any login credentials. For many computers, login credentials are required (e.g. username and password), but also, some level of physical protection is provided as the computer is often within a building or home and difficult to gain physical access. For security, the remote desktop protocols require that the remote computer present proper login credentials before allowing entry into the controlled computer, but remote desktop protocols lack the requirement of physical access. Therefore, someone having a computer's login credentials is able to access that computer through remote desktop protocols from anywhere in the world.

Most computers having the latest operating system updates are safe, as long as all users of the computer maintain proper security, including using strong passwords and not allowing others to access those passwords. Unfortunately, many usernames and passwords have been compromised and can be found on the “dark web.” Also, unfortunately, many users create simple passwords or utilize the same passwords across many logins (e.g. “passw0rd1”). Therefore, if a banking server is hacked and the user's bank account password is compromised, the same password allows a hacker to gain access to that user's home computer and, possibly, that user's work computer—through remote desktop protocols.

What is needed is a system that will block malicious access to computers through remote desktop protocols.

### SUMMARY

A system for protecting against remote desktop protocol intrusions monitors the remote desktop protocol in a target computer, looking for connections (or attempted connections) from a connecting device (e.g. a remote computer). Upon detecting the connection (or attempted connection), an intrusion detection module determines if the connecting device is authorized to make a remote desktop protocol connection to the target computer, in some embodiments, using white lists and/or black lists. In some embodiments, the intrusion detection module communicates with a verification program the must be run on the connecting device and tries to receive a packet containing an identification of the connecting device. If the packet is not received or the connecting device is not authorized, the intrusion detection module disconnects the connection from the connecting device.

In one embodiment, a system for protecting a computer from malicious remote desktop protocol attacks includes intrusion detection software running on the computer. A remote computer has verification software running there on. The intrusion detection software monitors a remote access protocol and detects a remote access connection to the computer by the remote computer by way of the remote access protocol. After the intrusion detection software detects that the remote access connection has been made and a new logon session is initiated, the intrusion detection software attempts to make a test connection to verification software that runs on the remote computer and if the connection fails or if the test connection times out, the intrusion detection software declares the remote computer to be malicious and the intrusion detection software terminates the remote access connection.

In another embodiment, a method of protecting a computer from malicious remote desktop protocol attacks from a remote computer include monitoring a remote access protocol and detecting a remote access connection to the computer by the remote computer by way of a remote access protocol. After detecting that the remote access connection has been made and a new logon session is initiated, an attempt to make a test connection to verification software that runs on the remote computer is made and if the test connection fails or if the test connection times out, it is declared the remote computer to be malicious and the remote access connection is terminated.

In another embodiment, program instructions are tangibly embodied in a non-transitory storage medium for protecting a computer from malicious remote desktop protocol attacks from a remote computer. The at least one instruction includes computer readable instructions running on the computer monitor a remote access protocol and detects a remote access connection to the computer by the remote computer by way of a remote access protocol. After the computer readable instructions running on the computer detects that the remote access connection has been made and a new logon session is initiated, the computer readable instructions running on the computer attempts to make a test connection to verification software that runs on the remote computer and if the test connection fails or if the test connection times out, the computer readable instructions running on the computer declares the remote computer to be malicious and the computer readable instructions running on the computer the terminates the remote access connection.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the prior art.

FIG. 2 illustrates a data connection diagram of the system for protecting against remote desktop protocol intrusions.

FIG. 3 illustrates a transaction diagram of the prior art.

FIG. 4 illustrates a transaction diagram of the system for protecting against remote desktop protocol intrusions.

FIG. 5 illustrates a schematic view of a typical user computer protected by the system for protecting against remote desktop protocol intrusions.

FIGS. 6, 7, and 8 illustrate program flows of the system for protecting against remote desktop protocol intrusions.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the computer security system provides a level of protection from intrusions that utilize any remote desktop protocol.

Throughout this description, the term, “user computer” refers to any system that has a processor and runs software, and is capable of remote access through a remote desktop protocol. One example of such is a personal computer. Another example is a smartphone or tablet. The term, “user” refers to a human that has an interest in the computer, perhaps a user who is using the computer. The term “connecting device” is used to connote a remote device (e.g. computer) that attempts to connect to a target computer using a remote desktop protocol. Although, in some systems, the term “remote desktop protocol” refers to a specific remote access protocol, the described system is intended to protect any system using any types of remote access protocol. Throughout this description, the term, “remote access protocol” is used to describe such, including what is known as remote desktop protocol.

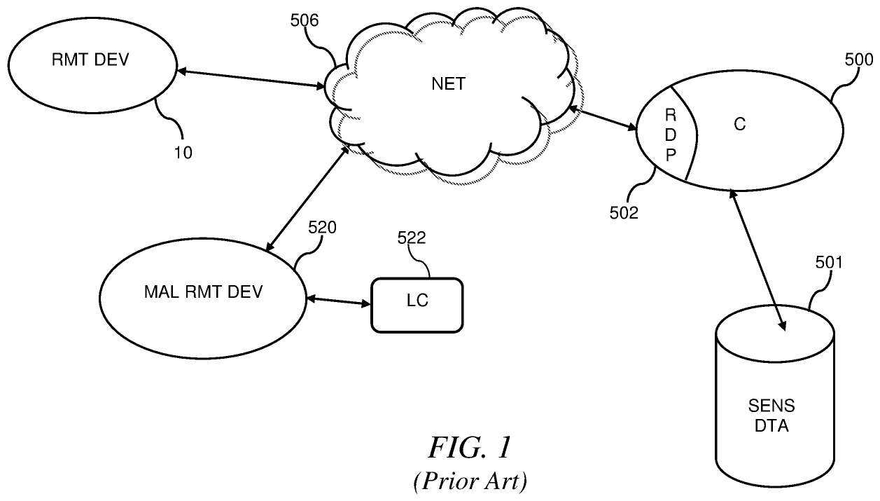

Referring to FIG. 1, a data connection diagram of the prior art is shown. In this example, a remote device 10 (e.g., personal computer, smartphone) connects to the target computer 500 (as known in the industry) through a network 506 (e.g. the Internet, local area network, etc.) utilizing a remote access protocol 502. The target computer 500 has access, for example, to data storage 501 as an example, containing sensitive information (e.g. banking information, company data, tax returns, etc.).

In this example, the remote device has legitimate access to the target computer 500, for example, access by a remote technical support technician having login credentials for the target computer 500.

In this example of the prior art, another remote device, a malicious remote device 520 is also accessing the target computer 500 through the network 506 utilizing the remote access protocol 502. Having login credentials 522 for any user on the target computer 500, the malicious remote device 520 gains access to the target computer 500 through the remote access protocol 502. Once access is made, the malicious remote device 520 has the ability to access any data interfaced to the target computer 500, including, for example, sensitive data 501. Further, the malicious remote device 520 has the ability to change settings on the target computer 500 (e.g. disable antivirus protection, disable firewalls), has the ability to install malicious software, and has the ability to encrypt all data connected to the target computer 500 (e.g. for ransomware purposes).

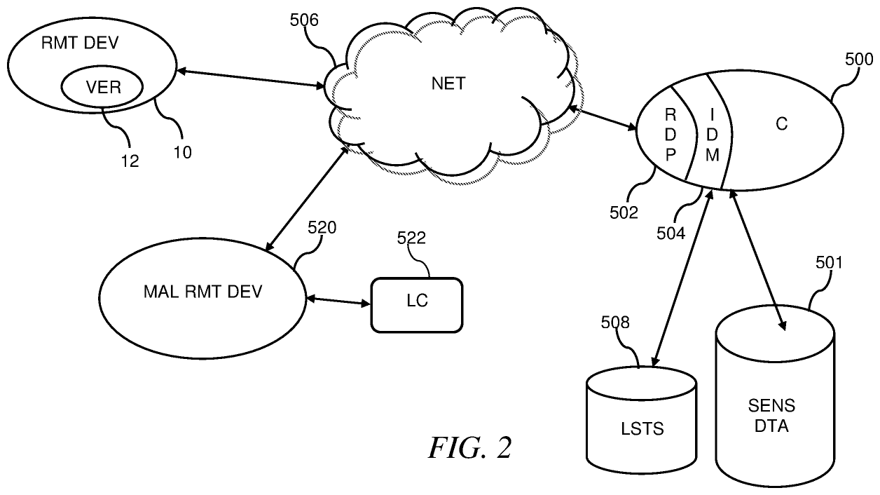

Referring to FIG. 2, a data connection diagram of the system for protecting against remote access protocol intrusions is shown. Again, in this example, a remote device 10 (e.g., personal computer, smartphone) connects to the target computer 500 (as known in the industry) through a network 506 (e.g. the Internet, local area network, etc.). To access the target computer 500, a remote access protocol 502 (stack) runs on the target computer 500 and accepts connections from such remote devices 10. The target computer 500 has access, for example, to data storage 501 as an example, containing sensitive information (e.g. banking information, company data, tax returns, etc.).

In this example, the remote device 10 has legitimate access to the target computer 500, for example, access by a remote technical support technician having login credentials for the target computer 500.

In this example, another remote device, a malicious remote device 520 is also accessing the target computer 500 through the network 506 utilizing the remote access protocol 502. The malicious remote device 520 has login credentials 522 for a user on the target computer 500. In the past, the malicious remote device 520 was able to gain access to the target computer 500 through the remote access protocol 502 having the login credentials 522.

The system for protecting against remote access protocol intrusions inserts an intrusion detection module 504 for protection against malicious remote devices 520. The intrusion detection module 504 implements either a watch port or a plugin onto the remote access protocol 502.

In the example of a watch port, the watch port signals the intrusion detection module 504 when a new logon session is to be initiated. This action occurs slightly after a connection is made, but before there is sufficient time for any malicious activity to be performed

In the example of a plugin, the plugin is installed onto the remote access protocol 502 and, as soon as a connection is established, the plugin attempts a connection to a verification program 12 that runs on all remote devices 10 that are authorized.

In some embodiments, as soon as a remote access protocol connection or login is detected, antivirus software running on the target computer is signaled to temporarily prevent activation of new processes. Therefore, even if it takes a few milliseconds for the following strategies to determine that the connection is being made by a malicious remote device 520, the malicious remote device 520 is not able to initiate any programs on the target computer 500.

There are multiple strategies for determining if the connecting device is a remote device 10 that is authorized or if the connecting device is a malicious remote device 520. One strategy includes the intrusion detection module 504 attempting a connection to the verification program 12 that runs on all remote devices 10 that are authorized. If the connection to the verification program 12 cannot be made or times-out (e.g. the verification program 12 is not installed), it is assumed that the remote device is a malicious remote device 520. As it is anticipated that malicious remote devices 520 will determine the need to have a verification program 12, in some embodiments, the verification program 12 must send one or more packets of data to the intrusion detection module 504. In some embodiments, the packet of data includes an identification of the remote device 10 such as a computer identification or phone number of the remote device. In some embodiments, the identification is encrypted. If the verification program 12 does not send the requisite packet of data, it is assumed that the remote device is a malicious remote device 520.

Another strategy includes lists 508 (black lists and/or white lists) of approved (white lists) or malicious (black list) addresses. In this, it is anticipated that after the connecting device connects to the target computer 500, the IP address of the connecting device is available to the intrusion detection module 504. In some embodiments, the lists 508 include a white list of IP addresses (or ranges of IP addresses) that are approved for connection to the target computer 500. In some embodiments, the lists 508 include a black list of IP addresses (or ranges of IP addresses) that is not approved for connection to the target computer 500. Examples of black lists are “all IP addresses from a particular country” or “all IP addresses not from the United States,” or “an IP address of a known malicious entity.”

In any case, once it is determined that the connecting device is a malicious remote device 520, the connection is terminated. In embodiments in which antivirus software running on the target computer was signaled to temporarily prevent activation of new processes, once the connection is terminated, the antivirus software is signaled to enable initiation of programs on the target computer 500.

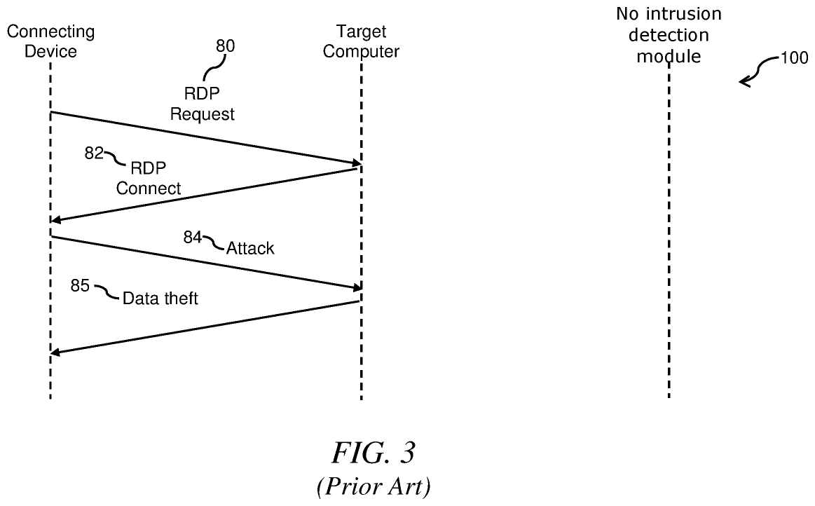

Referring to FIG. 3, a transaction diagram 100 of the prior art is shown. In this, a connecting device makes a connection request 80 using a remote desktop protocol. Assuming the connecting device has the login credentials of a user of the target computer 500 (e.g. obtained from the dark web), the target computer 500 accepts the connection 82. If the connecting device is a malicious remote computer 520, the malicious remote computer 520 initiates an attack 84 (e.g. using file transfer protocols to forward sensitive data 501 to the malicious remote device 520, disabling antivirus software, disabling firewalls . . . ) resulting in, for example, data theft 85 and other malicious activities such as encryption of all data connected to the target computer 500 as part of a ransom scheme.

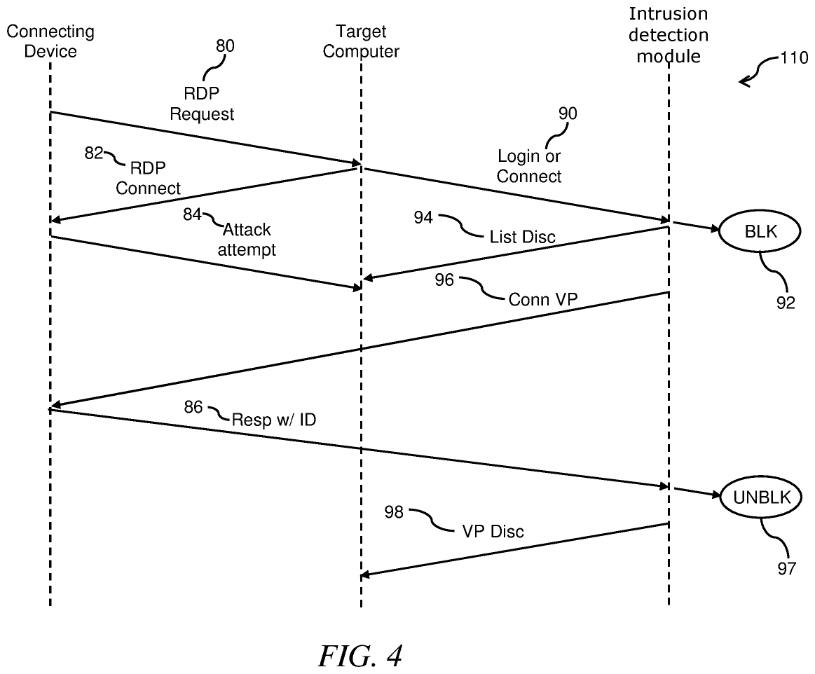

Referring to FIG. 4, a transaction diagram 110 of the system for protecting against remote access protocol intrusions is shown. In this, a connecting device makes a connection request 80 using a remote desktop protocol. Assuming the connecting device has the login credentials of a user of the target computer 500 (e.g. obtained from the dark web), the target computer 500 accepts the connection 82.

At the same time or shortly after, the intrusion detection module 504 is notified 90 of the login attempt and/or the connection being established. In some embodiments, the intrusion detection module 504 blocks 92 any new programs from executing until the intrusion detection module 504 determines if the connecting device is authorized. In some embodiments, the intrusion detection module 504 blocks 92 any new programs related to the new session (connection) from executing until the intrusion detection module 504 determines if the connecting device is authorized.

In embodiments with lists 508, the intrusion detection module 504 compares the connection data to the lists 508 and if the connection data indicates that the connecting device is not known (not on white list) or is blacklist (it is on the black list), the intrusion detection module 504 initiates a disconnect to disconnect from the connecting device that is now connected. If the list 508 method is inconclusive or in embodiments not having the list 508 method, the intrusion detection module 504 connects 96 to the verification program 12 that is expected to be running on the connecting device. It is expected that the verification program 12 accept the connection and respond 86 with the requisite data within an expected timeframe. If the verification program responds 86 with the expected data within the expected timeframe and the intrusion detection module 504 previously blocked 92 any new programs from executing, the intrusion detection module 504 unblocks 97 (now allows) new programs to execute. If the verification program does not respond 86 with the expected data within the expected timeframe, the intrusion detection module 504 declares that the connecting device is a malicious remote device 520 and the intrusion detection module 504 initiates disconnection 98 with the connecting device, preventing any further action by the connecting device before the malicious remote computer 520 is able to initiate an attack 84 (e.g. using file transfer protocols to forward sensitive data 501 to the malicious remote device 520, disabling antivirus software, disabling firewalls . . . ).

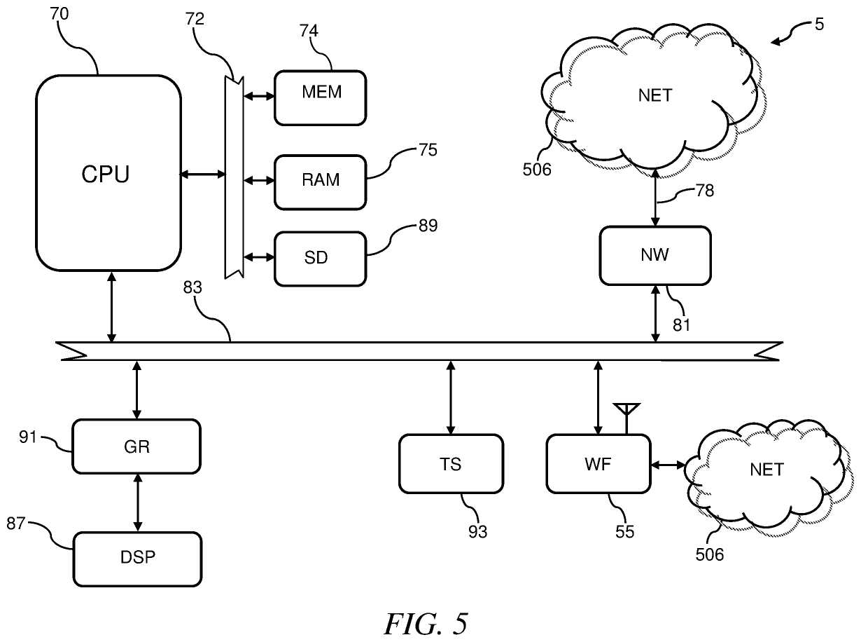

Referring to FIG. 5, a schematic view of a typical computer system 5 used as an example of the remote device 10, the malicious remote device 520, or the target computer 500 is shown. The present invention is in no way limited to any particular typical computer system 5. Many typical computers 5 that are processor-based devices are anticipated including, but not limited to smartphones, cellular phones, portable digital assistants, personal computers, smart watches, cordless phones, etc.

The example typical computer system 5 is shown to represent a typical computer system 5. This exemplary typical computer system 5 is shown in its simplest form. Different architectures are known that accomplish similar results in a similar fashion, and the present invention is not limited in any way to any particular architecture or implementation. In this exemplary typical computer system 5, a processor 70 executes or runs programs in a random-access memory 75. The programs are generally stored within a persistent memory 74 and loaded into the random-access memory 75 when needed. In some computer systems 5, a removable storage 89 (e.g., compact flash, SD) offers removable persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some embodiments, the persistent memory 74 is removable, in the form of a memory card of appropriate format such as SD (secure digital) cards, micro SD cards, compact flash, etc.

Also connected to the processor 70 is a system bus 83 for connecting to peripheral subsystems such as a network interface 81, a graphics adapter 91 and a touch screen interface 93. The graphics adapter 91 receives commands from the processor 70 and controls what is depicted on the display 87. The touch screen interface 93 provides navigation and selection features.

In general, some portion of the persistent memory 74 and/or the removable storage 89 is used to store programs, executable code and data, etc. In some embodiments, other data is stored in the persistent memory 74 such as audio files, video files, text messages, tax returns, etc.

The peripherals are examples, and other devices are known in the industry such as Global Positioning Subsystems, speakers, microphones, USB interfaces, cameras, microphones, Bluetooth transceivers, Wi-Fi transceiver 55, image sensors, temperature sensors, etc., the details of which are not shown for brevity and clarity reasons.

The network interface 81 connects the typical computer system 5 to the network 506 (e.g. Internet) through any known or future protocol such as Ethernet (IEEE 802.3), etc. There is no limitation on the type of connection used. The network interface 81 provides data connections between the typical computer systems 5 through any network 506. In some embodiments, the Wi-Fi transceiver 55 is used to connect to the network 506.

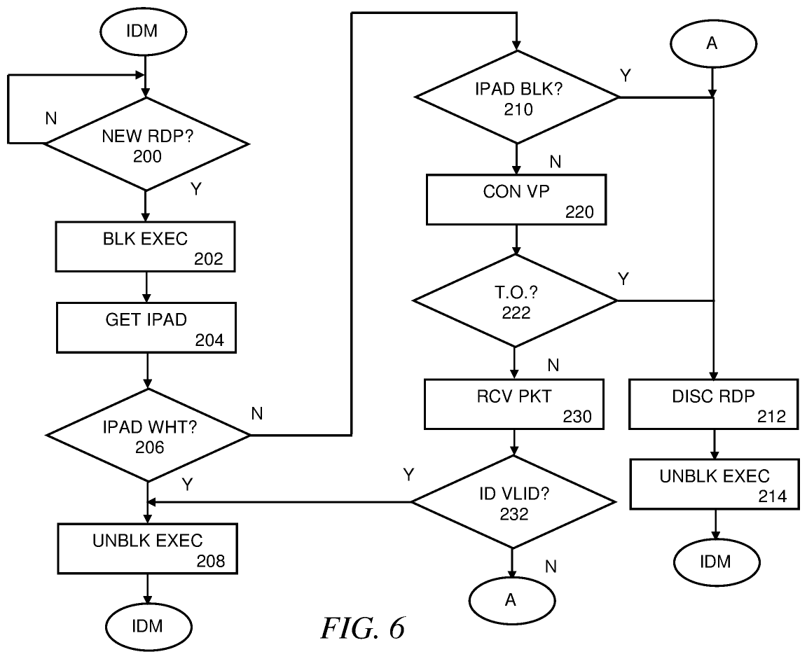

Referring to FIGS. 6, 7, and 8, exemplary program flows of the system for protecting against remote access protocol intrusions are shown. In FIG. 6, the intrusion detection module 504 waits 200 for a connecting device to make a new connection request using a remote desktop protocol. In some embodiments, the new connection is recognized using a “watch port.” In some embodiments, any other operating system function is anticipated for determining when a new remote access is made, for example, monitoring TCP ports, a callback application programming interface, etc.

Assuming the connecting device has the login credentials of a user of the target computer 500 (e.g. obtained from the dark web) or for some reason the target computer 500 allows such connections without authorization, the target computer 500 will accept the connection.

As previously discussed, in some embodiments, the intrusion detection module 504 blocks the execution 202 of any new programs until the intrusion detection module 504 determines if the connecting device is authorized. Now the intrusion detection module 504 gets the IP address 204 of the connecting device.

The intrusion detection module 504 determines if the IP address is in the lists 508. If 206 the IP address is in the white list, the intrusion detection module 504 unblocks 208 previously blocked execution and starts over again, looking for new connections over the remote desktop protocol.

Otherwise, if the IP address is in the black list 210, the intrusion detection module 504 initiates a disconnect 212 to disconnect from the connecting device that is now connected and unblocks 214 previously blocked execution and starts over again, looking for new connections over the remote desktop protocol.

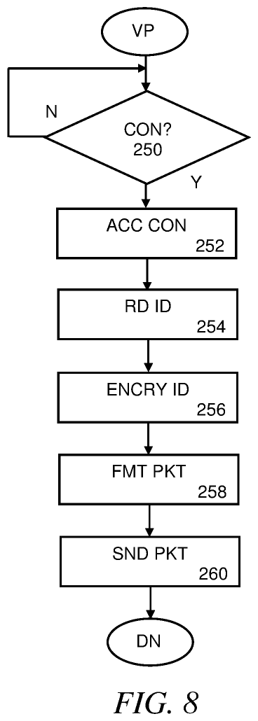

Next, the intrusion detection module 504 connects 220 to the verification program 12 that is expected to be running on the connecting device. It is expected that the verification program 12 accept the connection and respond with the requisite data within an expected timeframe (see FIG. 8). If the connection times out 222, the intrusion detection module 504 initiates a disconnect 212 to disconnect from the connecting device that is now connected and unblocks 214 previously blocked execution and starts over again, looking for new connections over the remote desktop protocol.

Next, the intrusion detection module 504 receives the data packet(s) 230 from the verification program 12 and determines if it is valid 232. If the data packet(s) 230 from the verification program 12 is valid 232, the intrusion detection module 504 unblocks 208 previously blocked execution and starts over again, looking for new connections over the remote desktop protocol.

If the data packet(s) 230 from the verification program 12 is not valid 232, the intrusion detection module 504 initiates a disconnect 212 to disconnect from the connecting device that is now connected and unblocks 214 previously blocked execution and starts over again, looking for new connections over the remote desktop protocol.

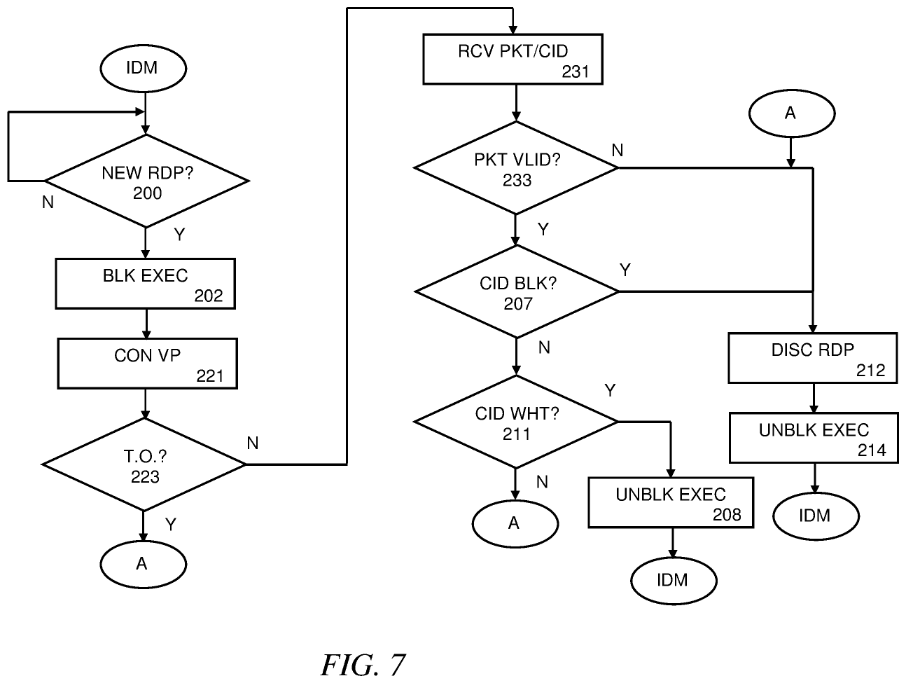

In FIG. 7, another exemplary program flow is shown in which there is no reliance upon the IP address of the device that is trying to connect to the computer (connecting device). Instead, a computer identification is received from the verification program (see FIG. 8) running on the connecting device and the computer identification is tested for validity.

The intrusion detection module 504 waits 200 for a connecting device to make a new connection request using, for example, a remote desktop protocol. In some embodiments, the new connection is recognized using a “watch port.” In some embodiments, any other operating system function is anticipated for determining when a new remote access is made, for example, monitoring TCP ports, a callback application programming interface, etc.

Assuming the connecting device has the login credentials of a user of the target computer 500 (e.g. obtained from the dark web) or for some reason the target computer 500 allows such connections without authorization, the target computer 500 will accept the connection.

As previously discussed, in some embodiments, the intrusion detection module 504 blocks the execution 202 of any new programs until the intrusion detection module 504 determines if the connecting device is authorized. Note that the step of blocking execution 202 is optional and in some embodiments, there is no blocking of execution (and therefore, no unblocking 208/214 of execution). Now the intrusion detection module 504 gets the IP address 204 of the connecting device.

Next, the intrusion detection module 504 connects 221 to the verification program 12 that is expected to be running on the connecting device. It is expected that the verification program 12 accept the connection and respond with the requisite data within an expected timeframe (see FIG. 8). If the connection times out 223, the intrusion detection module 504 initiates a disconnect 212 to disconnect from the connecting device that is now connected and then unblocks 214 previously blocked execution and starts over again, looking for new connections over the remote desktop protocol.

Next, the intrusion detection module 504 receives the data packet(s) 231 from the verification program 12 and determines if it is valid 233. If the data packet(s) from the verification program 12 is not valid 233, the intrusion detection module 504 initiates a disconnect 212 to disconnect from the connecting device that is now connected and then unblocks 214 previously blocked execution and starts over again, looking for new connections over the remote desktop protocol.

If the data packet(s) from the verification program 12 is valid 233, the intrusion detection module 504 determines if the computer identification (CID) is in the lists 508. If 207 the computer identification (CID) is in the black list, the intrusion detection module 504 initiates a disconnect 212 to disconnect from the connecting device that is now connected and unblocks 214 previously blocked execution and starts over again.

Otherwise, if the computer identification (CID) is in the white list 211, the intrusion detection module 504 allows the connection to remain connected and unblocks 208 previously blocked execution and starts over again, looking for new connections over the remote desktop protocol.

If the computer identification (CID) is not in the white list 211, (e.g. not in the white list and not in the black list) the intrusion detection module 504 initiates a disconnect 212 to disconnect from the connecting device that is now connected and unblocks 214 previously blocked execution and starts over again, looking for new connections over the remote desktop protocol.

In FIG. 8, the verification program 12 that is expected to be running on the connecting device is shown. The verification program 12 waits for an incoming connection 250 from the intrusion detection module 504. Once an incoming connection 250 is detected, the verification program 12 accepts the connection 252 then read/obtains a computer identification (CID) 254 of the connecting device, for example, a computer name, IP address, computer identification, or a phone number of a smartphone, etc. Next, the verification program 12 encrypts 256 the identification and formats one or more packets 258 including the encrypted identification, then sends the packet(s) 260 over the connection back to the intrusion detection module 504.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for protecting a computer from malicious remote desktop protocol attacks, the system comprising:
intrusion detection software running on the computer;
a remote computer;
verification software running on the remote computer;
the intrusion detection software monitors a remote access protocol and detects a remote access connection to the computer by the remote computer by way of the remote access protocol;
after the intrusion detection software detects that the remote access connection has been made and a new logon session is initiated, the intrusion detection software attempts to make a test connection to verification software that runs on the remote computer and if the test connection fails or if the test connection times out, the intrusion detection software declares the remote computer to be malicious and the intrusion detection software terminates the remote access connection.

2. The system of claim 1, wherein after the intrusion detection software attempts to make the test connection to the verification software that runs on the remote computer, the intrusion detection software waits for reception of at least one packet of data over the test connection and if the at least one packet of data is not received or a connection timeout occurs, the intrusion detection software declares the remote computer to be malicious and the intrusion detection software terminates the remote access connection.

3. The system of claim 2, wherein after the at least one packet of data is received, the intrusion detection software searches a table of expected values for the data and if the data is not found in the table of expected values, the intrusion detection software declares the remote computer to be malicious and the intrusion detection software terminates the remote access connection.

4. The system of claim 3, wherein the table of expected values includes computer identifications of approved remote computers.

5. The system of claim 3, wherein the table of expected values includes phone number of approved remote computers.

6. The system of claim 1, wherein after detecting that the remote access connection has been made and the new logon session is initiated, the intrusion detection software blocks any new programs from executing until the intrusion detection software determines that the remote computer is authorized.

7. A method of protecting a computer from malicious remote desktop protocol attacks from a remote computer, the method comprising:
monitoring a remote access protocol and detecting a remote access connection to the computer by the remote computer by way of the remote access protocol;
after detecting that the remote access connection has been made and a new logon session is initiated, attempting to make a test connection to verification software that runs on the remote computer and if the test connection fails or if the test connection times out, declaring the remote computer to be malicious and terminating the remote access connection.

8. The method of claim 7, wherein after attempting to make the test connection to the verification software that runs on the remote computer, waiting for reception of at least one packet of data over the test connection and if not receiving the at least one packet of data or timing out of the test connection, declaring the remote computer to be malicious and terminating the remote access connection.

9. The method of claim 7, wherein after receiving the at least one packet of data, searching a table of expected values for the data and if finding one of the expected values from the table of expected values in the data, declaring the remote computer to be safe.

10. The method of claim 9, if not finding one of the expected values from the table of expected values in the data, declaring the remote computer to be malicious and terminating the remote access connection.

11. The method of claim 9, wherein the table of expected values includes computer identifications of approved remote computers.

12. The method of claim 9, wherein the table of expected values includes phone number of approved remote computers.

13. The method of claim 9, wherein after detecting that the remote access connection has been made and the new logon session is initiated, blocking any new programs from executing until declaring the remote computer to be safe.

14. Program instructions tangibly embodied in a non-transitory storage medium for protecting a computer from malicious remote desktop protocol attacks from a remote computer, the at least one instruction comprises:
computer readable instructions running on the computer monitors a remote access protocol and detects a remote access connection to the computer by the remote computer by way of the remote access protocol;
after the computer readable instructions running on the computer detects that the remote access connection has been made and a new logon session is initiated, the computer readable instructions running on the computer attempts to make a test connection to verification software that runs on the remote computer and if the test connection fails or if the test connection times out, the computer readable instructions running on the computer declares the remote computer to be malicious and the computer readable instructions running on the computer the terminates the remote access connection.

15. The program instructions tangibly embodied in the non-transitory storage medium of claim 14, wherein after the computer readable instructions running on the computer attempts to make the test connection to the verification software that runs on the remote computer, the computer readable instructions running on the computer waits for reception of at least one packet of data over the test connection and if the computer readable instructions running on the computer do not receive the at least one packet of data or the test connection times out, the computer readable instructions running on the computer declares the remote computer to be malicious and the computer readable instructions running on the computer terminates the remote access connection.

16. The program instructions tangibly embodied in the non-transitory storage medium of claim 15, wherein after the computer readable instructions running on the computer receive the at least one packet of data, the computer readable instructions running on the computer searches a table of expected values for the data and if the computer readable instructions running on the computer find one of the expected values from the table of expected values in the data, the computer readable instructions running on the computer declare the remote computer to be safe.

17. The program instructions tangibly embodied in the non-transitory storage medium of claim 15, if the computer readable instructions running on the computer do not find one of the expected values from the table of expected values in the data, the computer readable instructions running on the computer declare the remote computer to be malicious and the computer readable instructions running on the computer terminate the remote access connection.

18. The program instructions tangibly embodied in the non-transitory storage medium of claim 15, wherein the table of expected values includes computer identifications of approved remote computers.

19. The program instructions tangibly embodied in the non-transitory storage medium of claim 15, wherein the table of expected values includes phone number of approved remote computers.

20. The program instructions tangibly embodied in the non-transitory storage medium of claim 14, wherein after the computer readable instructions running on the computer detect that the remote access connection has been made and the new logon session is initiated, the computer readable instructions running on the computer blocks any new programs from executing until the computer readable instructions running on the computer declare the remote computer to be safe.
